(19) United States
(12) Patent Application Publication
(10) Pub. No.: US 2006/0176146 A1
(43) Pub. Date: Aug. 10, 2006

(54) Wireless universal serial bus memory key with fingerprint authentication

(76) Inventors: Baldev Krishan, Fremont, CA (US); Gurminder Singh, Cupertino, CA (US)

Correspondence Address: G. VICTOR TREYZ, FLOOD BUILDING, 870 MARKET STREET, SUITE 984, SAN FRANCISCO, CA, 94102, US

(21) Appl. No.: 11/055,365

(22) Filed: Feb. 9, 2005

(51) Int. Cl. G06K 9/00

(52) U.S. Cl. 340/5.53; 713/186; 726/28; 340/5.61; 382/115

(57) ABSTRACT

A wireless universal serial bus (USB) memory key with fingerprint authentication capabilities is provided. The USB memory key contains memory for storing data files. A fingerprint sensor in the wireless USB memory key is used to capture user fingerprints. Wireless transceiver circuitry in the USB memory key allows the memory key to be used to control external equipment. Following successful user authentication using the fingerprint sensor, the memory key may be used to wirelessly control door locks and other equipment.

### BACKGROUND OF THE INVENTION

This invention relates to universal serial bus (USB) memory keys, and more particularly, to wireless USB memory keys with fingerprint authentication.

USB memory keys contain flash memory. The flash memory is used to store files. A USB memory key may be used for temporary data storage or for transferring files between computers at different locations. A user might, for example, load files onto a USB memory key at work. At home, the user may insert the USB memory key into a USB port on a home computer to access the stored files.

Because of their popularity, USB memory keys are now being incorporated into penknives and novelty items. It has also been proposed to incorporate fingerprint sensors in USB memory keys so that they can be used for identity verification.

Although universal serial bus technology is widely deployed, it is not always desirable or practical to require the use of a USB port.

It is an object of the present invention to provide a USB memory key with fingerprint recognition and wireless capabilities.

### SUMMARY OF THE INVENTION

In accordance with the present invention, a universal serial bus (USB) memory key is provided. The USB memory key contains flash memory or other suitable memory. A user can store files in the memory (e.g., for file transfer between computers, etc.).

The USB memory key contains a fingerprint sensor. The fingerprint sensor is used to capture a fingerprint scan of a user. Authorized users can register their fingerprints. During authentication operations, a newly captured fingerprint is compared to registered fingerprints. If the newly captured fingerprint matches a registered fingerprint, it can be concluded that a user is authorized.

The USB memory key contains radio-frequency (RF) transceiver circuitry. The RF transceiver circuitry may be used to support a wireless link between the memory key and external computing equipment. The computing equipment may be part of a system such as a home security system, an vehicle control system, a computer network, etc. Authorized users may use the memory key to wirelessly interact with the computing equipment to perform desired functions. For example, authorized users can wirelessly prove their identities to computer networks to gain network access, authorized users can wirelessly open door locks and perform other control operations in a home or vehicle, and authorized users can wirelessly transfer data to and from the memory key's memory.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative wireless USB memory key with fingerprint authentication capabilities in accordance with the present invention.

FIG. 2 is a diagram of an illustrative wireless USB memory key with fingerprint authentication capabilities and a computer-based system with which the USB memory key interacts over a wireless link in accordance with the present invention.

FIG. 3 is a flow chart of illustrative set up steps involved in installing software and registering user fingerprints in accordance with the present invention.

FIG. 4 is a flow chart of illustrative steps involved in authenticating a user with the wireless USB memory key in accordance with the present invention.

FIG. 5 is a flow chart of illustrative steps involved in authenticating a user using a USB memory key and computing equipment in wireless communication with the USB memory key in accordance with the present invention.

FIG. 6 is a flow chart of illustrative steps involved in setting up and using a wireless USB key with fingerprint authentication capabilities in accordance with the present invention.

FIG. 7 is a flow chart of illustrative steps involved in automatically downloading a user's email to a USB memory key in accordance with the present invention.

FIG. 8 is a flow chart of illustrative steps involved in providing a user with access to downloaded email on the USB memory key in accordance with the present invention.

### DETAILED DESCRIPTION OF THE PREFERRED EMBODIMENTS

The present invention relates to wireless USB memory keys with fingerprint authentication capabilities and to methods for using such memory keys in computer-based systems.

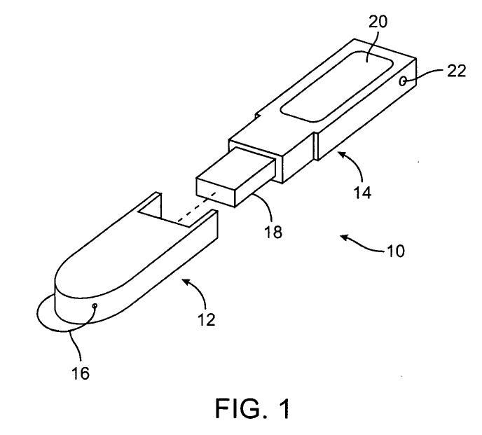

An illustrative wireless USB memory key with fingerprint authentication capabilities 10 is shown in FIG. 1. In the illustrative arrangement of FIG. 1, memory key 10 has cover portion 12 and a main body portion 14. The cover 12 and case of the main body portion 14 may be formed from plastic or other suitable materials. The cover 12 may have a metal ring 16 for attaching key 10 to a user's key chain (e.g., with their regular home and office keys).

Body 14 has a USB interface plug 18. During USB operations, plug 18 is inserted into a mating USB port. A fingerprint sensor window 20 is formed on body 14. A user may prove his identity by placing an appropriate finger (e.g., an index finger or thumb) against window 20. The key 10 may then scan the user's fingerprint and use the captured fingerprint information to authenticate the user. In the example of FIG. 1, sensor window 20 is shown as being formed on the top of body 14. If desired, sensor window 20 may be formed on another portion of body 14 such as the side of body 14.

Memory key 10 has wireless communications circuitry that allows key 10 to interact with other equipment over wireless links. The wireless communications circuitry is preferably powered by a battery in key 10. If desired, the battery may be a rechargeable battery. A power port 22 may be used to receive direct current (DC) power from a mating alternating current (AC) power adapter. When the AC adapter is plugged into port 22, the rechargeable battery in key 10 is charged. After charging is complete, the plug can be removed from port 22.

The configuration of key 10 that is shown in FIG. 1 is merely illustrative. Other configurations may be used if desired. For example, the cover 12 may be hinged, rather than removable. Key 10 also need not use a cover. Ring 16 is optional and may be attached at different locations of key 10 (e.g., to body 14). The key 10 is preferably about one inch long, so that key 10 may be carried easily in a pocket, but may have different shapes than the shape shown in FIG. 1. If desired, the fingerprint sensor window 20 may be covered by a protective flap, a portion of cover 12, or other suitable protective structure.

Port 22 may be integrated with USB interface structure 18. With this type of arrangement, DC power for charging the rechargeable battery may be provided to key 10 automatically, whenever key 10 is inserted in a USB port. If desired, power may be applied to USB key 10 using both port 22 and USB interface 18. In this situation, DC power for charging the rechargeable battery and powering the circuitry of key 10 may be applied by plugging an AC adapter into port 22 and/or may be applied by plugging USB interface portion 18 into a USB port that supplies DC power.

If desired, key 10 may be provided with buttons. For example, key 10 may be provided with a button to perform a desired wireless operation (e.g., wirelessly opening the trunk of an automobile). Buttons may also be used to help a user adjust memory key settings, etc.

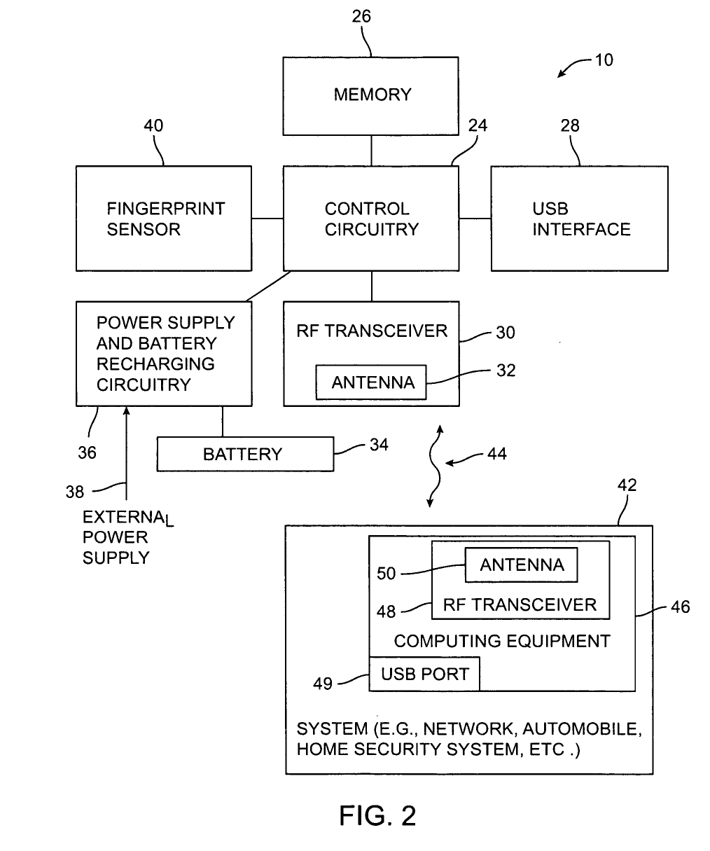

FIG. 2 shows a circuit diagram of an illustrative memory key 10 and a system 42 with which the USB memory key may interact in accordance with the present invention. As shown in FIG. 2, key 10 may have control circuitry 24 that controls the operation of key 10. Control circuitry 24 may be based on any suitable processing circuitry and may include, for example, a microprocessor, a microcontroller, a digital signal processor, an application-specific integrated circuit, etc. The circuitry of control circuitry 24 may be provided using a stand-alone integrated circuit or may be provided as part of an integrated circuit that performs multiple functions (e.g., input-output functions, etc.)

Key 10 has a USB interface 28. USB interface 28 is physically connected to the USB interface portion 18 of key body 14 (FIG. 1). USB interface 28 allows control circuitry 24 to send and receive data through a USB port into which key 10 has been plugged. An illustrative USB port 49 into which key 10 may be inserted is shown as being part of computing equipment 46 in FIG. 2. In general, key 10 may be inserted in any suitable USB port in any suitable computing equipment (e.g., personal computers and other computing equipment with and without wireless capabilities).

Although key 10 is shown as using a USB interface 28 in FIG. 2, any suitable wired input-output interface may be used. For example, key 10 may be configured to plug into a compact flash slot or other memory card slot, may be configured to plug into an RS-232 port or other serial or parallel I/O port, etc. Because USB technology is widely deployed, the present invention will be described in the context of a USB implementation of key 10 for clarity.

Memory 26 may be any suitable storage medium for storing data in key 10. In a preferred embodiment, memory 26 is non-volatile memory such as flash memory. If desired, volatile memory (e.g., dynamic random-access memory or static random-access memory) may be used as memory 26. More than one type of memory technology may also be used in memory 26. For example, volatile memory may be used to serve as a cache for instructions being executed by a processor in control circuitry 24 and non-volatile memory may be used for long-term data storage (e.g., for storage of user files).

Key 10 has a fingerprint sensor 40 that is used to read a user's fingerprint. The fingerprint sensor (also sometimes called a fingerprint reader) may be used to acquire a fingerprint scan for the user using the memory key 10. The fingerprint of the user can be used to establish the user's identity. If an unauthorized user attempts to use memory key 10, the fingerprint of the unauthorized user will not be valid, and access to services that require fingerprint authorization will be denied. If, however, an authorized user presents a valid fingerprint to sensor 40, the user can be allowed to log into a network, access stored data in memory 26, activate a lock or other mechanism through wireless commands, or perform other suitable actions that have been restricted to valid users.

The fingerprint data acquired by the fingerprint sensor may be stored using any suitable format. For example, data storage and transmission requirements may be reduced by using a data compression format suitable for fingerprint data (e.g., by noting unique minutia points such as ridge endings and bifurcations in a fingerprint and/or the positions of various fingerprint swirls and other characteristics, etc.). Whether the fingerprint data acquired by the fingerprint sensor 40 is a full fingerprint image or contains attributes derived from the image such as minutia points, the fingerprint data is referred to herein as a “fingerprint scan,” “fingerprint template,” or “fingerprint.”

If desired, memory key 10 may use another type of biometric sensor in place of or in addition to fingerprint sensor 40. A microphone and voice analysis techniques may be used, for example, to authenticate a user based on the user's unique voice print. Other biometric properties (e.g., retinal images, etc.) may also be measured using key 10. For clarity, the present invention will be described in the context of using fingerprints for biometric identification.

Fingerprint sensor 40 is particularly advantageous in situations in which it is desired to ensure that memory key 10 remains small and lightweight enough to be attached to a key chain and transported in a user's pocket. As shown in FIG. 1, the fingerprint sensor window 20 of fingerprint sensor 40 fits within the relatively small confines of memory key body 14.

As described in connection with FIG. 1, memory key 10 is preferably battery powered. As shown in FIG. 2, battery 34 may be connected to power supply and battery recharging circuitry 36. Power supply and battery recharging circuitry 36 receives external power from an external power supply at input 38. Input 38 may be, for example, connected to power supply port 22 of FIG. 1. In a preferred arrangement, input 38 of FIG. 2 receives DC power from an AC power adapter plugged into port 22.

The power received at input 38 is distributed by power supply and battery charging circuitry 36. When battery 34 is ready to be recharged, power supply and battery recharging circuitry 36 directs power from input 38 to battery 34 (e.g., in the form of a reverse-polarity DC current or reverse-polarity charging pulses). The control circuitry 24 and other portions of memory key 10 can be powered at the same time that battery 34 is being charged. If battery 34 is fully charged, power supply and battery recharging circuitry 36 may distribute applied power from external power supply input 38 to the appropriate components of key 10.

When the external power supply is removed, key 10 is powered by battery power from battery 34. In this mode of operation, battery 34 supplies power to power supply and battery recharging circuitry 36, which distributes this power to the components of key 10. If desired, battery 34 may be removable. When battery 34 is removable, key 10 contains a battery compartment for receiving fresh batteries. The power supply and battery recharging circuitry 36 may be used to recharge the batteries that are placed in the battery compartment or only non-rechargeable batteries may be supported. If only non-rechargeable batteries are used in memory key 10, circuitry 36 need only contain power supply circuitry for distributing battery power to the components of key 10. Battery charging circuitry would not be needed.

Radio-frequency (RF) transceiver 30 is used to support wireless communications between memory key 10 and external equipment. RF transceiver 30 preferably contains wireless transmitter and wireless receiver circuitry. Antenna 32 is used for transmitting and receiving wireless signals over wireless communications paths such as wireless link 44.

Transceiver 30 may be used to support any suitable wireless communications protocol, such as Bluetooth, WiFi (IEEE 802.11), etc. The range of RF transceiver 30 is generally limited to 10s or 100s of feet. Short-range wireless links of this type are preferred for memory key 10 because they reduce the possibility of interference with other equipment and may use unlicensed portions of the radiofrequency spectrum (e.g., 2.4 GHz). If desired, however, transceiver 30 may be used to support long-range wireless transmissions (e.g., cellular telephone transmissions). For clarity, the present invention will generally be described in the context of short-range wireless links.

The RF transceiver 30 allows memory key 10 to communicate with wireless-enabled computing equipment. In the example of FIG. 2, memory key 10 is shown as communicating with computing equipment 46 in a system 42. Computing equipment 46 may include one or more personal computers, handheld computers, mainframe computers, workstations, cellular telephones, embedded microcontroller and microprocessor systems, etc.

Computing equipment 46 includes an RF transceiver 48 having an antenna 50. Computing equipment 46 and memory key 10 use transceivers 30 and 40 to support wireless communications over wireless link 44. Some computing equipment (such as the illustrative computing equipment 46 shown in FIG. 2) includes one or more USB ports such as USB port 49. In general, memory key 10 can communicate using wired communications (e.g., using USB interface 28), wireless communications (e.g., using RF transceiver 30), or both wired and wireless communications. Preferably, memory key 10 chooses which type of communications path to use based on context (e.g., if only path 44 is available, memory key 10 will communicate wirelessly using RF transceiver 30). Certain functions (e.g., file transfer) may be supported only using one interface (e.g., USB interface 28 or RF transceiver 30) or these functions can be supported using both interfaces. In general, memory key 10 will communicate with computing equipment in which it is inserted using USB interface 28 or, if memory key 10 is not inserted in a USB port, will communicate wirelessly over path 44.

The computing equipment 46 may be used to support operations in a variety of system 42.

With one suitable arrangement, computing equipment 46 is a computer or network of computers in a home or business environment. Access to the computer network may be controlled using the fingerprint authentication capabilities of memory key 10.

With another suitable arrangement, computing equipment 46 is an embedded computer in a home security system or home automation system. The fingerprint authentication capabilities of the memory key 10 may be used to control access to the security system or home automation system. Once authenticated, a user can direct the home security system or home automation system to perform a suitable action such as opening an electromagnetically-controlled front door lock, opening or closing a garage door, turning on or off a burglar alarm, adjusting settings in these systems, etc.

Yet another example involves computing equipment 46 in an embedded system 42 in a vehicle. The fingerprint authentication capabilities of memory key 10 may be used to ensure that a user's identity is correct, after which the memory key may wirelessly issue commands that control automobile functions (e.g., unlocking electromagnetically controlled automobile door locks, ignition switches, trunk latches, etc.).

As these examples demonstrate, there are a variety of applications in which it is important to restrict access to system operations to authorized users. Controlling access to a computer network, controlling physical entry into a home, controlling entry into and operation of a vehicle, are, however, merely illustrative examples of how wireless memory key 10 may be used. In general, computing equipment 46 may be based on any suitable hardware platform and may be included in any suitable system 42.

In order to ensure that only an appropriately authorized user (or users) is able to access system 42, the biometric information (e.g., the fingerprint) that is used to identify an authorized user in the system should be collected and stored with appropriate entities. The process of gathering a user's fingerprint scan and storing the fingerprint scan for use in subsequent user authentication operations is called fingerprint registration.

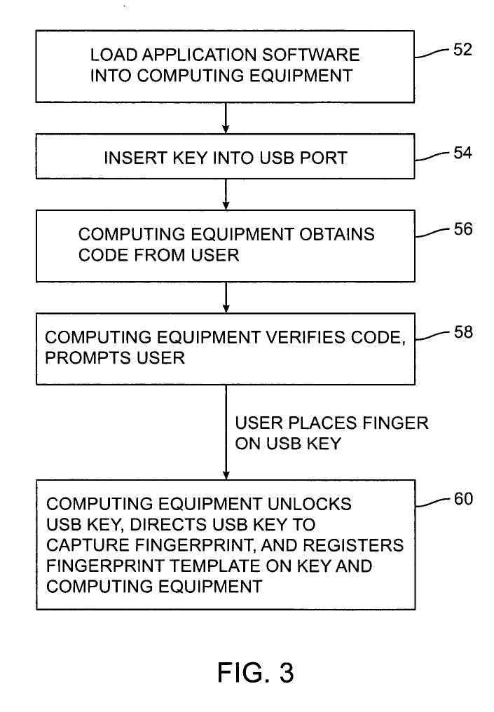

Illustrative steps involved in setting up a system and registering a user's fingerprint with the system are shown in FIG. 3. At step 52, application software for supporting the authentication operations of memory key 10 is loaded into computing equipment 46. The application software for supporting memory key authentication operations may be provided to computing equipment 46 as part of its native operating system, as a downloaded application, or using any other suitable approach. Memory key 10 may be loaded with appropriate application software during initialization operations, as part of the manufacturing process, or during subsequent operations. Memory keys such as memory key 10 are preferably sold or otherwise provided to users in a blank state, without any preregistered fingerprint information. To avoid unauthorized fingerprint registration, the software loaded at step 52 may include a secret code that is used to authorize users prior to initial fingerprint registration operations.

At step 54, a user who desires to register a fingerprint with memory key 10 inserts memory key 10 into the USB port 49 of computing equipment 46 into which the appropriate registration software has been loaded. (Alternatively, wireless communications between memory key 10 and computing equipment 46 may be established by placing memory key 10 in wireless range of computing equipment 46.)

The computing equipment 46 detects that the memory key 10 has been inserted into the USB port (or that key 10 and equipment 46 are in wireless range). Accordingly, at step 56, the computing equipment obtains the secret code from the user. Any suitable arrangement may be used for obtaining the secret code. With one suitable arrangement, the purchaser of memory key 10 is provided with a secret code in the packaging materials accompanying key 10. The corresponding application software loaded into computing equipment 46 prompts the user to type in the secret code during step 56. The user consults the printed materials and types the code into an on-screen text entry box on computing equipment 46.

After the computing equipment 46 obtains the secret code from the user, the computing equipment uses a secret code verification algorithm to determine whether the entered code is valid. The code verification process may involve consulting a list of authorized codes and/or performing code manipulations to determine whether the characteristics of the code prove its validity.

If the computing equipment 46 determines that the code supplied by the user is not authentic, the computing equipment 46 can conclude that the user is not authorized to use the memory key 10 and can decline to allow the user to register a new fingerprint. If desired, the user may be presented with a notification that the code could not be verified.

If the computing equipment 46 verifies that the code supplied by the user is valid, the computing equipment 46 may prompt the user to place an index finger or other suitable finger on sensor window 20 (FIG. 1) of fingerprint sensor 40 (FIG. 2).

After the user has placed the finger on fingerprint sensor window 20 (FIG. 1) of the fingerprint sensor 40 (FIG. 2), the computing equipment 46 uses sensor 40 to capture the fingerprint of the user. With one suitable approach, computing equipment 46 unlocks the memory key 10, directs the memory key 10 to perform a fingerprint scan, and registers the captured fingerprint. Fingerprint registration operations may involve storing captured fingerprint data at key 10 (e.g., in memory 26), storing a captured fingerprint at computing equipment 46, or storing fingerprint data in both key 10 and computing equipment 46.

To protect key 10 against attacks, key 10 may only be allowed to register new users if it has been “unlocked.” The unlocking process may involve the transmission of an unlock command from computing equipment 46 to memory key 10 (in response, e.g., to correct entry of the secret code from the printed materials). Memory key 10 stays “locked” to prevent unauthorized fingerprint registration during normal use. When memory key 10 receives the unlock command from computing equipment 46, memory key 10 knows that it is safe to register a new user.

If the fingerprint of the registered user is stored in memory 26 during step 60, memory key 10 may perform local fingerprint verification operations without consulting computing equipment 46. If the fingerprint of the registered user is stored at computing equipment 46 during step 60, authentication operations may be performed by capturing the fingerprint with memory key 10 and transmitting the captured fingerprint to computing equipment 46 (e.g., wirelessly or using a wired path) for verification at computing equipment 46.

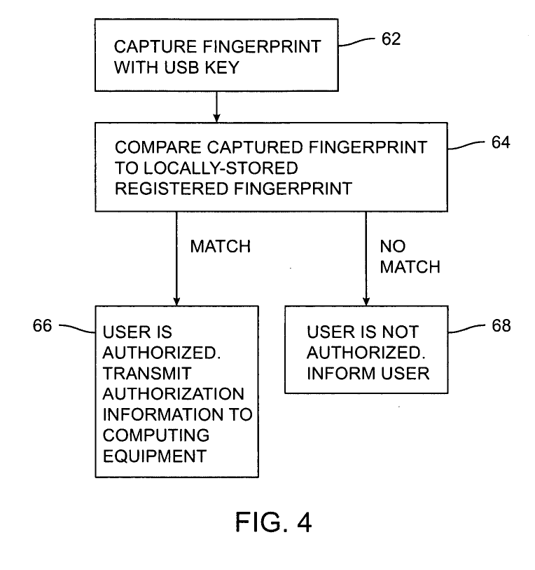

Illustrative steps involved in local fingerprint authentication operations at memory key 10 are shown in the flow chart of FIG. 4. At step 62, the fingerprint of a user is captured with fingerprint sensor 40. Fingerprint capture operations may be initiated when a user presses a button, when key 10 receives a command from computing equipment 46, when memory key 10 detects (e.g., through electrostatic properties) that a user has placed a finger in contact with sensor window 20, or using any other suitable approach.

At step 64, the memory key 10 may compare the captured fingerprint to the registered fingerprint that was stored at the memory key.

If the newly captured fingerprint of the user matches the registered fingerprint, the memory key 10 can conclude that the user is authorized. Accordingly, at step 66, the memory key can perform actions that require successful user authentication. These activities may include, for example, the transfer of data files between computing equipment 46 and memory key 10 or the operation of a particular function in system 42.

If the newly captured fingerprint of the user does not match the registered fingerprint, the memory key 10 can conclude that the user who is requesting authorization is not authorized to use the memory key. If desired, the memory key can provide feedback to the user. As an example, a failed authorization attempt may be accompanied by an audible signal or other information to instruct the user to make another attempt at authorization (e.g., by cleaning the fingerprint scanner pad).

With the approach of FIG. 4, the memory key 10 captures and verifies the fingerprint locally (i.e., without need to communicate with computing equipment 46). After the user has been verified, the user can be allowed to perform system functions with memory key 10.

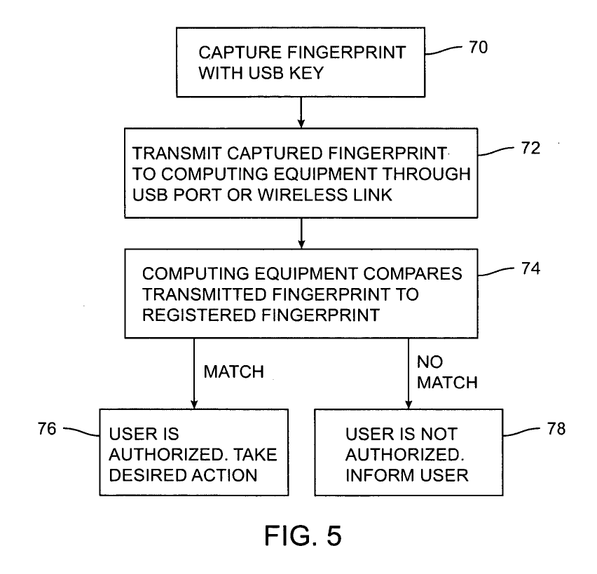

A verification approach that involves transmission of the newly captured fingerprint to the computing equipment 46 is shown in FIG. 5. With this type of approach, verification is not performed locally in the memory key, but rather is performed in the host computing equipment 46. The memory key 10 need only be used to capture the fingerprint.

At step 70, the fingerprint of the user is captured using the fingerprint sensor in the memory key 10. Fingerprint capture operations may be initiated by the computing equipment 46, by key 10 (e.g., in response to depression of a button on key 10), or automatically by detection of the presence of a finger on sensor 40.

At step 72, after the fingerprint of the user has been captured at step 70, the memory key 10 transmits the captured fingerprint to the computing equipment 46. The captured fingerprint may be transmitted using a wired path (e.g., through USB interface 28 of FIG. 2) or may be transmitted over wireless link 44 (e.g., using an RF transmitter in transceiver 30 and an RF receiver in RF transceiver 48).

At step 74, the computing equipment 46 receives the transmitted fingerprint and compares this newly captured fingerprint to the registered fingerprint stored at the computing equipment 46.

If the newly captured fingerprint matches the registered fingerprint, the computing equipment 46 can conclude that the user is authorized to use the system 42 and can take appropriate actions at step 76.

If the newly captured fingerprint does not match a registered fingerprint, the computing equipment 46 can conclude that the user is not authorized to use system 42. The user may therefore be provided with a warning or other suitable information at step 78. For example, computing equipment 46 and/or memory key 10 may generate an audible tone, may present a visual indicator that authentication has failed, or may take any other suitable actions.

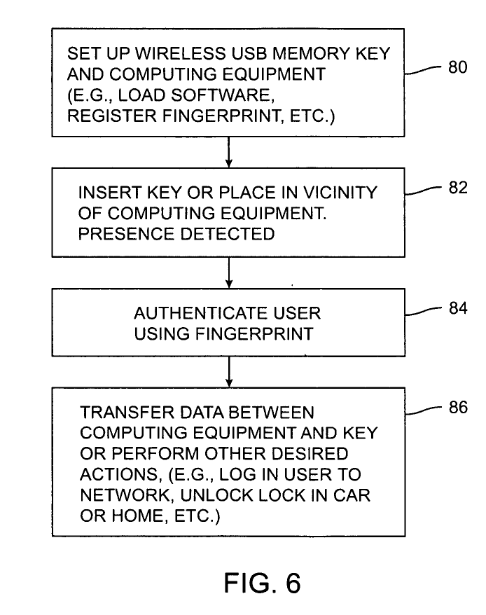

Illustrative steps involved in using memory key 10 in interactions with system 42 are shown in FIG. 6.

At step 80, the wireless USB memory key 10 and computing equipment 46 are set up (e.g., using operations of the type described in connection with FIG. 3 to load software, register fingerprints or other suitable biometric information, etc.).

At step 82, the user inserts memory key 10 into a USB port 49 (FIG. 2) to establish a wired communications link between memory key 10 and computing equipment 46 or places the memory key 10 in wireless range of computing equipment 46 to establish a wireless link 44 between memory key 10 and computing equipment 46.

At step 84, the user places a finger on the fingerprint sensor of memory key 10. The fingerprint is captured and compared to the registered fingerprints in the system. If the fingerprint matches, the user is authorized.

Following successful user authentication operations at step 84, the system 42 may be used to perform suitable functions for the user at step 86.

For example, the user may be interested in moving stored data files from the memory 26 of memory key 10 to a hard disk or other storage in computing equipment 46 or may be interested in transferring data from computing equipment 46 to memory key 10. The computing equipment 46 can use the fingerprint authentication operations of step 84 to restrict network access to valid users and/or may use fingerprint authentication to control whether the user can move the stored data files. If the user has been authenticated successfully, the user may be logged into the system and/or allowed to transfer desired files. Files can be transferred wirelessly or through a wired path.

As another example, computing equipment 46 may be part of a home security system or a home automation system. The computing equipment 46 may control functions such as door locks, lights, etc. At step 86, the user may access these system capabilities, because the computing equipment 46 knows that the user is authorized.

Another example concerns vehicle control. Memory key 10 may be used to communicate with a vehicle's control system (computing equipment 46). Memory key 10 may communicate with this computing equipment 46 through a wired path or over wireless link 44. Because the identity of the user has been successfully authenticated at step 84, the user may be permitted to perform functions such as controlling the vehicle's door locks, ignition, trunk, etc. Buttons on memory key 10 may be used to issue appropriate commands for the vehicle and/or actions may be taken automatically. For example, following successful authentication of the user, the door locks of the vehicle can be automatically opened by computing equipment 46.

If desired, other systems may be controlled using memory key 10. The control of computer network access, data transfer operations, building access, and vehicle access are merely illustrative examples showing how the wireless USB memory key with fingerprint authentication may be used.

The USB memory key 10 may be used to automatically download email messages. For example, whenever the USB memory key detects an available internet connection, the USB memory key can access a user's mail server and download the user's email. The user may be alerted when email messages are present. For example, the user may be alerted to the presence of available email messages by displaying an alert on a computer with which the USB memory key is in communication or by notifying the user using an audible or visible alert generated by a transducer in the USB memory key. Following fingerprint authentication using the USB memory key, the user may be provided with access to the user's email.

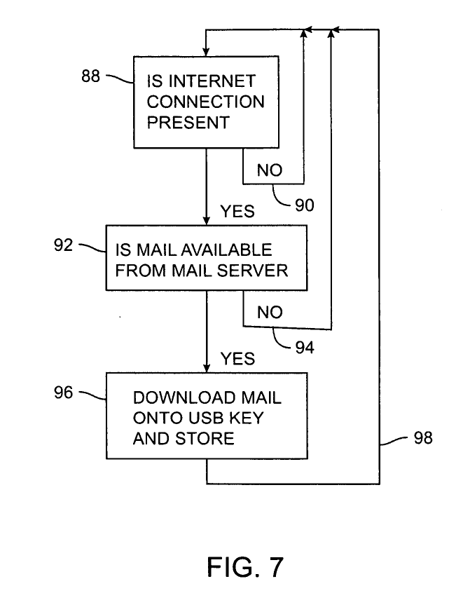

Illustrative steps involved in using the USB memory key 10 to automatically retrieve email messages are shown in FIG. 7. At step 88, the USB memory key 10 determines whether there is an internet connection available. The USB memory key may be plugged into a computer that has an internet connection or may be in wireless communication with a computer that has an internet connection.

If there is no available internet connection over which the USB memory key can communicate, processing loops back to step 88, as shown by line 90.

If there is an available internet connection, at step 92 the USB memory key determines whether there is mail available on the user's mail server. The user may provide the USB memory key 10 with information on the user's email account during a setup phase. Later, at step 92, the USB memory key 10 uses this account information to contact and log into the correct mail server to determine whether email is available.

If no email is available, processing loops back to step 88, as shown by line 94.

If email is available for downloading, the USB memory key downloads the email messages at step 96. The downloaded email messages are stored in memory 26. If the USB memory key 10 has internet access by virtue of being plugged into a USB port on a computer with an internet connection, the email is downloaded through the USB interface 28. If the USB memory key 10 has internet access by virtue of a wireless connection 44 with a computer with internet access, the email is downloaded through the RF transceiver 30.

Following the downloading and storage of the user's email, processing loops back to step 88, as shown by line 98.

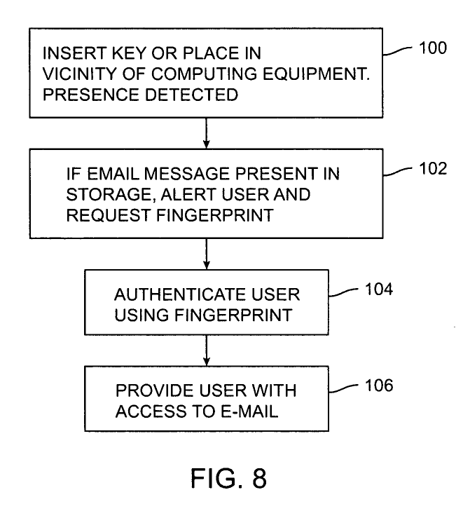

To prevent unauthorized access to the user's email, the USB memory key 10 preferably requires that a fingerprint be provided before the email messages are released from memory 26. Illustrative steps in using fingerprint authentication to provide a user with access to email on USB memory key 10 are shown in FIG. 8.

At step 100, the USB memory key 10 is inserted in a USB port or is placed within wireless range of computing equipment (e.g., a personal computer). The computing equipment detects the presence of the USB memory key 10 and establishes a communications link.

At step 102, the USB memory key 10 and/or the computing equipment determines whether email messages are present in the memory 26. If email is present, the user is alerted. Any suitable technique may be used to alert the user. For example, the computing equipment with which the USB memory key is communicating may display an on-screen alert message. As an alternative, or in conjunction with the on-screen message, the USB memory key may turn on a light on the USB memory key, may make a sound, or may otherwise notify the user that email is available. By displaying these alerts or other suitable messages for the user, the user is informed that the user should place a finger in contact with the fingerprint sensor to begin the fingerprint authentication process.

At step 104, the USB memory key 10 uses the fingerprint sensor 40 to capture a fingerprint to authenticate the user. If the fingerprint authentication process is not successful, the user can be notified accordingly.

If the fingerprint authentication process is successful, the user can be provided with access to the email messages stored in memory 26. For example, the email messages may be displayed on the computing equipment with which the USB memory key is in communication using an email client operating on the computing equipment.

The foregoing is merely illustrative of the principles of this invention and various modifications can be made by those skilled in the art without departing from the scope and spirit of the invention.

What is claimed is:

1. A method for using a wireless universal serial bus (USB) memory key with a fingerprint sensor, comprising:
capturing a fingerprint of a user with the fingerprint sensor in the USB memory key to authenticate the user; and
if the captured fingerprint indicates that the user is authorized, using the wireless USB memory key to wirelessly control computing equipment in a system.

2. The method defined in claim 1 wherein the system comprises a home having an electromagnetically-controlled door lock and wherein using the wireless USB memory key to wirelessly control the computing equipment comprises using the wireless USB memory key to wirelessly control the door lock in the home.

3. The method defined in claim 1 wherein the system comprises a vehicle having an electromagnetically-controlled door lock and wherein using the wireless USB memory key to wirelessly control the computing equipment comprises using the wireless USB memory key to wirelessly control the door lock in the vehicle.

4. The method defined in claim 1 wherein the system comprises a computer network and wherein using the wireless USB memory key to wirelessly control the computing equipment comprises using the wireless USB memory key to permit access by the user to the computer network.

5. The method defined in claim 1 wherein using the wireless USB memory key to wirelessly control the computing equipment comprises using the wireless USB memory key to transfer user-stored data files from the wireless USB memory key to the computing equipment.

6. The method defined in claim 1 wherein using the wireless USB memory key to wirelessly control the computing equipment comprises using the wireless USB memory key to wirelessly transfer user-stored data files from the wireless USB memory key to the computing equipment.

7. The method defined in claim 1 further comprising registering at least one user fingerprint with the wireless USB memory key by storing a registered user fingerprint in the wireless USB memory key.

8. The method defined in claim 1 further comprising registering at least one user fingerprint by storing a registered user fingerprint in the computing equipment.

9. The method defined in claim 1 further comprising comparing the captured fingerprint to a registered fingerprint stored in the wireless USB memory key to determine whether the user is authorized.

10. The method defined in claim 1 further comprising:
transmitting the captured fingerprint to the computing equipment; and
at the computing equipment, comparing the captured fingerprint to a registered fingerprint stored at the computing equipment to determine whether the user is authorized.

11. The method defined in claim 1 further comprising:
wirelessly transmitting the captured fingerprint to the computing equipment; and
at the computing equipment, comparing the captured fingerprint to a registered fingerprint stored at the computing equipment to determine whether the user is authorized.

12. The method defined in claim 1 further comprising powering the wireless USB memory key using a battery in the wireless USB memory key.

13. A wireless universal serial bus (USB) memory key with fingerprint authentication, comprising:
memory for storing data;
a USB interface for supporting USB communications;
a fingerprint sensor;
a radio-frequency (RF) transceiver for supporting wireless communications; and
control circuitry connected to the memory, USB interface, fingerprint sensor, and RF transceiver.

14. The wireless USB memory key defined in claim 13 further comprising a battery that supplies power to the USB memory key.

15. The wireless USB memory key defined in claim 13 further comprising:
a battery that supplies power to the USB memory key;
battery charging circuitry connected to the battery; and
a power supply input connected to the battery charging circuitry that supplies direct current (DC) power to the battery charging circuitry, wherein when the battery charging circuitry receives the DC power at the power supply input, the battery charging circuitry charges the battery.

16. The wireless USB memory key defined in claim 13 further comprising a key chain attachment ring.

17. A method for using a universal serial bus (USB) memory key with a fingerprint sensor to provide email to a user, comprising:
using the USB memory key to automatically download email messages over the internet;
storing the downloaded email messages in memory in the USB memory key;
using the fingerprint sensor to capture a fingerprint of the user;
authenticating the user using the captured fingerprint; and
if the user is authenticated successfully, using the USB memory key to provide the user with access to the stored email messages.

18. The method defined in claim 17 further comprising:
using the USB memory key to automatically detect whether an internet connection is available for downloading the email messages.

19. The method defined in claim 17 further comprising:
using the USB memory key to form a wireless communications link with computing equipment that has an internet connection; and
downloading the email messages to the USB memory key over the wireless communications link.
